(19) United States
(12) Patent Application Publication
(10) Pub. No.: US 2018/0189991 A1
(43) Pub. Date: Jul. 5, 2018

(54) SYSTEM AND METHOD OF DISPLAYING DIGITAL FLOWERS AT A FUNERAL

(71) Applicant: Eldrick McKinney, Bonaire, GA (US)

(72) Inventor: Eldrick McKinney, Bonaire, GA (US)

(21) Appl. No.: 15/396,538

(22) Filed: Dec. 31, 2016

(51) Int. Cl. G06T 11/60; G06F 3/0482; G06F 3/0484; G06F 17/30

(52) U.S. Cl. CPC G06T 11/60; G06F 17/30274; G06F 3/04842; G06F 3/0482

(57) ABSTRACT

A system and method to display digital flowers at a funeral comprises a display device, a user terminal, and a memory unit. The memory unit stores a database comprising images of the digital flowers, and a set of program modules. The system further comprises a processor to execute the set of program modules. The set of program modules comprises a user display module, to present a user with images of the digital flowers. An input module, executed by the processor, configured to receive a user input and at least one remark and condolence from the user. The user input comprises at least one digital flower selected by the user. The set of program modules further comprises an output module, executed by the processor, to display the at least one digital flower and the at least one remark and condolence on the display device.

### BACKGROUND OF THE INVENTION

A. Technical Field

The present invention generally relates to the technical field of digital flowers, and more specifically relates to system and method of displaying the digital flowers at a funeral.

B. Description of Related Art

Electronic devices have pervaded every aspect of life in the twenty first century. Examples of the electronic devices include but are not limited to televisions, computers, smartphones, and tablet computers. Today, users access the electronic devices for multiple purposes. Sometimes, users access the electronic devices for sending condolences to bereaved family members of recently deceased people.

In accordance with an existing etiquette in society, a user sends condolences to the bereaved family members along with a bouquet of flowers. However, often the bouquet of flowers are expensive. Further, practice of sending the bouquet of flowers is resource intensive, labor intensive, and cost intensive. Further, alternatives like digital flowers are cheap compared to the bouquet of flowers.

Therefore, there is a need in the art for a system and method for displaying digital flowers at funerals.

### SUMMARY OF THE INVENTION

The present invention relates to a system and method for displaying digital flowers at a funeral.

In one embodiment of the present invention, a system to display digital flowers at a funeral comprises a display device, a user terminal, and a memory unit. The memory unit stores a database comprising one or more images of one or more digital flowers, and a set of program modules. The system further comprises a processor to execute the set of program modules. The set of program modules comprises a user display module, executed by the processor, configured to present a user with images of the one or more digital flowers. An input module, executed by the processor, configured to receive a user input and at least one remark and condolence from the user. The user input comprises at least one digital flower selected by the user. Further, the set of program modules comprises an output module, executed by the processor, to display the at least one digital flower and the at least one remark and condolence on the display device.

In one embodiment of the present invention, the display device is at least one of a Liquid Crystal Display Television, a Light Emitting Diode Television, a Plasma Television and a smartphone. The user display module displays the one or more images on at least one of a personal computer, a smart phone, a tablet computer, and a webpage. The database further comprises Universal Resource Locators (URL) to more information about the one or more digital flowers.

In one embodiment of the present invention, a computer implemented method of displaying digital flowers at a funeral comprises storing in a memory unit, one or more images of one or more digital flowers. Further, the method comprises presenting, by a processor via a user display module, a user with images of the one or more digital flowers. Further, the method comprises receiving, by the processor via an input module, a user input wherein the user input comprises at least one digital flower selected by the user. Further, the method comprises displaying by the processor via an output module, the at least one digital flower on a display device.

### BRIEF DESCRIPTION OF DRAWINGS

FIG. 1 is a block diagram of a system for display digital flowers at a funeral in accordance with various embodiments of the invention.

FIG. 2 is flow chart of a computer-implemented method of displaying digital flowers at a funeral, according to yet another embodiment of the present invention.

FIG. 3 is a screenshot view a mobile application according to yet another embodiment of the present invention.

FIG. 4 is a screenshot view of display device according to yet another embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

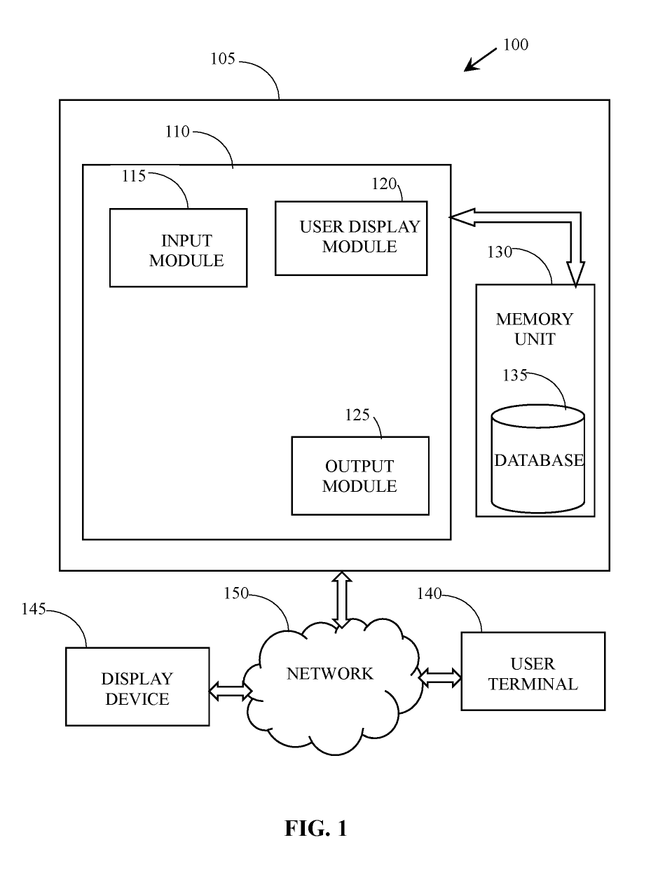

FIG. 1 is a block diagram of system 100 for displaying digital flowers at a funeral in accordance with one embodiment of the present invention. In one embodiment of the present invention, the system 100 is implemented in a device 105. In one embodiment of the present invention, the device 105 is a server. In another embodiment of the present invention, the device 105 is at least one of a laptop, a personal computer, a smart phone, a smart television, and a tablet computer. In yet another embodiment of the present invention, the device 105 is integrated inside a display device 145. Examples of the display device include, but is not limited to Liquid Crystal Display Television, Light Emitting Diode based televisions, and plasma televisions. In another example, the device 105 is physically separated from the display device 145 and communicates with the display device 145 via a network 150. The network 150 is at least one of a Local Area Network, a Wide Area Network, a Wireless Network, a telecommunication network, a mobile network, and Internet. In one example, the network 150 enables the user to communicate with the device 105. In another example, the user directly controls the device 105.

Further, the device 105 comprises a processor 110, and a memory unit 130. The memory unit 130 is at least one of a volatile memory, non-volatile memory, Read Only memory (ROM), Random Access Memory (RAM), and a flash memory. The memory unit 130 comprises a database 135 of one or more images of one or more digital flowers, and a set of program modules. The set of program modules comprises an input module 115, a user display module 120, and an output module 125. The database 135 further comprises Universal Resource Locators (URL) to more information about the one or more digital flowers. The user display module 120 executed by the processor 110 is configured to present a user with images of the one or more digital flowers. The user display module 120 displays the one or more digital flowers in a user terminal 140. The user terminal 140 is at least one of a smart phone, a personal computer, a tablet computer, a smart television and a laptop. In one example, the user display module 120 displays the one or more digital flowers on a web page. The user terminal 140 communicates with the device 105 via the network 150. Further, the input module 115, executed by the processor 110, is configured to receive a user input. The user input comprises at least one digital flower selected by the user. The output module 125, executed by the processor 110, is configured to display the at least one digital flower on the display device 145. The display device 145 is placed at the funeral. In one example, the device 105 and the display device 145 is controlled and owned by a second user. The second user receives a payment from the user for permitting the display of the at least one digital flower on the display device 145.

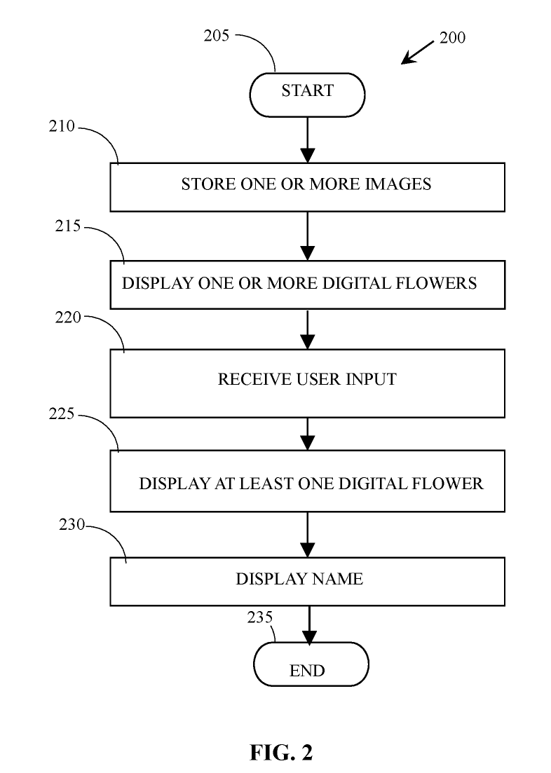

FIG. 2 is a flowchart of a computer-implemented method 200 of displaying digital flowers at a funeral in accordance with an embodiment of the present invention. In one example, the method 200 is implemented inside a device connected to a network. The method 200 commences at step 205.

At step 210, one or more images of one or more digital flowers are stored in a memory unit.

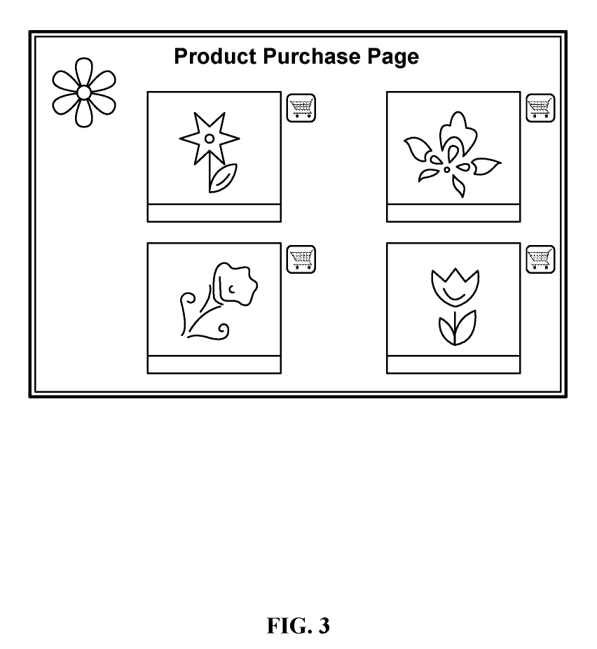

At step 215, a user is presented with images of the one or more digital flowers presenting, by a processor via a user display module. FIG. 3 is a screenshot view of a mobile application presenting the one or more digital flowers, according to yet another embodiment of the present invention.

At step 220, a user input and at least one remark and condolence is received from the user, by the processor via an input module. The user input comprises at least one digital flower selected by the user.

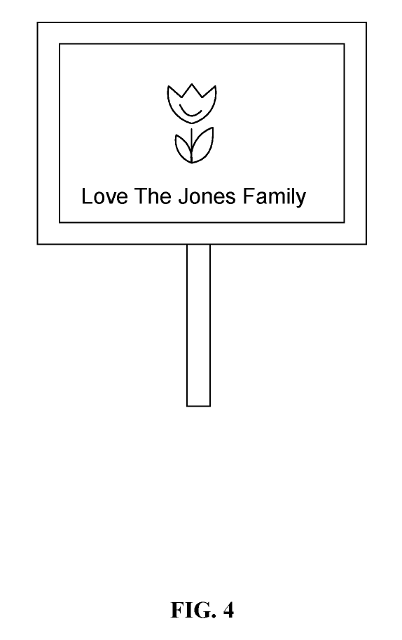

At step 225, the at least one digital flower is displayed on a display device. The processor causes the display device to display the digital flowers via an output module. FIG. 4 is a screenshot view of the display device according to yet another embodiment of the present invention. At step 230, the at least one remark and condolence is displayed on the display device.

The method 200 ends at step 235.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A system to display digital flowers at a funeral, the system comprising:
a display device;
a memory unit to store:
a database comprising one or more images of one or more digital flowers, and
a set of program modules; and
a processor to execute the set of program modules, wherein the set of program modules comprise:
a user display module, executed by the processor, configured to present a user with images of the one or more digital flowers;
an input module, executed by the processor, configured to receive a user input and at least one remark and condolence from the user, wherein the user input comprises at least one digital flower selected by the user; and
an output module, executed by the processor, configured to display the at least one digital flower and the at least one remark and condolence on the display device.

2. The system of claim 1, wherein the display device is at least one of a Liquid Crystal Display Television, a Light Emitting Diode Television, a Plasma Television and a smartphone.

3. The system of claim 1, wherein the user display module displays the one or more images on at least one of a personal computer, a smart phone, a tablet computer, and a webpage.

4. The system of claim 1, wherein the database further comprises Universal Resource Locators (URL) to more information about the one or more digital flowers.

5. A computer implemented method of displaying digital flowers at a funeral, the method comprising:
storing in a memory unit, one or more images of one or more digital flowers;
presenting, by a processor via a user display module, a user with images of the one or more digital flowers;
receiving, by the processor via an input module, a user input and at least one remark and condolence from the user, wherein the user input comprises at least one digital flower selected by the user; and
displaying by the processor via an output module, the at least one digital flower and the at least one remark and condolence on a display device.

6. The method of claim 5, wherein the display device is at least one of a Liquid Crystal Display Television, a Light Emitting Diode Television, a Plasma Television and a smartphone.

7. The method of claim 5, wherein the user display module displays the one or more images on at least one of a personal computer, a smart phone, a tablet computer, and a webpage.

8. The method of claim 5, wherein the database further comprises Universal Resource Locators (URL) to more information about the one or more digital flowers.
